(19) United States
(12) Patent Application Publication
(10) Pub. No.: US 2010/0263247 A1
(43) Pub. Date: Oct. 21, 2010

(54) Forehead adhesive display

(76) Inventor: Thomas A. Liguori, Poway, CA (US)

Correspondence Address: William Propp, Esq., 8205 Santa Monica Blvd, PMB1-245, West Hollywood, CA, 90046, US

(21) Appl. No.: 12/386,583

(22) Filed: Apr. 21, 2009

(51) Int. Cl. G09F 21/02; G09F 7/12; G09F 13/20

(52) U.S. Cl. 40/542; 40/586

(57) ABSTRACT

A forehead adhesive display has a flexible display sheet with an ink printed display on the top surface and a reusable adhesive on the bottom surface for removably attaching the flexible display sheet to the forehead of the wearer. The display can also be a light display with a plurality of light emitting diodes or a liquid crystal display.

### BACKGROUND OF THE INVENTION

This invention is a display for a wearer's body, specifically a display to be adhesively attached to the forehead of the wearer, which is easy to apply, easy to remove, and reusable.

Messages or displays are sometimes printed on the front or back of T-shirts, which limits clothing choices.

A display on a wearer's body can be used to support a sports team or a cause, for advertising a commercial product or service, or simply to draw attention to the wearer. The object of the display is to be viewed by a second party.

The oldest and most common display on a wearer's body is body paint.

A graphic, logo, words and/or letters are drawn on the body using a suitable ink, dye or paint. Brushes, sponges, markers or fingers are used to form the body paint display.

Body paint is difficult for the wearer to apply by herself or himself. It is difficult for a non-artist wearer to draw accurately and draw well. It is difficult to apply body paint as a reverse image so the message appears correctly to the viewer. It is equally difficult to apply body paint with a mirror to get a reverse image. And certain body areas are simply out of reach for the wearer attempting to body paint.

The skin of the wearer may be allergic to the paint. The wearer cannot easily remove the paint and reposition new paint in a slightly different body location. Paint is difficult to remove and is not reusable.

A variation of body paint is a temporary tattoo on the wearer's body. A temporary tattoo can be applied by one of two methods: stencil or wetting.

In the stencil method, a stencil covers a portion of the wearer's body. The display of the temporary tattoo is formed in the empty spaces or holes in the stencil. The wearer sprays, rolls or paints the temporary tattoo ink in the empty spaces or holes in the stencil to form the display. The stencil is then removed leaving a temporary tattoo with the display on the wearer's body.

A stencil is best used on the chest, arms, or front of the legs of the wearer. It is impossible for the wearer himself or herself to apply the temporary tattoo ink through a stencil on the back of the wearer. It is difficult to apply a temporary tattoo through a stencil on the wearer's face since the wearer may have his vision blocked by the stencil and the temporary tattoo ink may get into the eyes, nose or mouth of the wearer.

In the wetting method, the reverse image of the temporary tattoo is inked onto a carrier sheet. A protective sheet covers the temporary tattoo ink and carrier sheet until use. The protective sheet is usually transparent or translucent to show the reverse image of the temporary tattoo underneath the protective sheet.

In use, the protective cover is peeled from the temporary tattoo and carrier sheet. The tattoo and carrier sheet are wetted. The reverse image tattoo is placed against the skin of the wearer in a selected position. The wet tattoo will adhere to the skin and the carrier sheet will be removed leaving the correct image temporary tattoo on the body of the wearer.

A temporary tattoo of a corporate name or team logo is applied to the exposed skin of a cheerleader or dance squad member at an athletic event in United States Published Patent Application 20020136876. The location specified in this patent application is the abdomen of a cheerleader.

Whether applied by stencil or by wetting, the tattoos are not reusable and they are not easily removed. The skin may have an allergic reaction to the tattoo ink. It is difficult for a wearer to apply a tattoo to himself and impossible to remove and reposition the tattoo.

An anti-glare decal bearing a logo is attached to the skin of the cheek under the eye of the wearer in U.S. Pat. No. 5,939,142. The decal can alternatively be a temporary tattoo.

The anti-glare decal is usually black or another dark color and always a non-reflective matte to reduce the reflection of direct or indirect light off the wearer's cheek into the wearer's eye.

Any logo or message on the decal is typically so small that it can only be viewed when the wearer's face is on television.

An advertising message is displayed on the upper back and shoulders of the wearer in U.S. Pat. No. 6,742,293. The message can be made with preformed letters or numbers and attached by adhesive to the back and shoulder. Alternately, the message can be applied directly to the skin with dye, ink or paint.

A message display on the back is impossible for the wearer to apply herself or himself. The positioning and spacing of individual numbers and letters is problematic and difficult to self-apply.

A typical human back has hairs. An adhesive display on the back will be removable but painful as the hairs are pulled, if not torn away, from the wearer's skin.

The display is to be viewed by a second party. A message on the back of a wearer requires the wearer to be facing away from the viewer.

It is an object of this invention to provide a display on the forehead of the viewer.

It is another object of this invention to provide a removable and reusable display.

### SUMMARY OF THE INVENTION

According to the present invention, a forehead adhesive display has a flexible display sheet with an ink printed display on the top surface and a reusable adhesive on the bottom surface for removably attaching the flexible display sheet to the forehead of the wearer.

The adhesive attaches the flexible display sheet to a backing sheet. The flexible display sheet is peeled from the backing sheet and attached to the forehead of the wearer. The flexible display sheet is later peeled from the forehead of the wearer and reattached onto the backing sheet or some other surface, until the forehead adhesive display is used again on the forehead of a wearer.

The flexible display sheet is thin, relatively soft and flexible. Possible display sheet materials include, but are not limited to, be plastic, paper, polymer, cotton, metal foil or linen.

The display is printed on the flexible display sheet in ink or paint or some other substitute. The display can be a name, a logo, a mascot, a slogan, a pattern, a message, or blank. The display can be letters, numbers, symbols, graphics, geometric designs, non-geometric designs or some combination thereof.

The reusable adhesive is a low-tack, reusable, pressure sensitive, adhesive.

The flexible display sheet is generally oval or generally elliptical in shape, having a long axis and a short axis. The generally oval or generally elliptical shape of the flexible display sheet of the forehead adhesive display allows the flexible display sheet to fit the curving surface of the forehead.

The oval or elliptical flexible display sheet can be curved along the long axis to better fit the slightly curved forehead and the sharp curve from the forehead to the side of the head on both sides.

The ink for printing the display can be a fluorescent ink or a luminescent ink.

The forehead adhesive display can be a light display having a plurality of light emitting diodes illuminates the display. The plurality of light emitting diodes are positioned between a first flexible display sheet and a second flexible display sheet. The plurality of light emitting diodes extend through the first flexible display sheet to form a display on the top surface of the first flexible display sheet.

The plurality of light emitting diodes will be electrically connected to a power source, an on/off switch and, optionally, a control circuit, all positioned between the first flexible display sheet and the second flexible display sheet. The power source can be a watch battery or any other thin flat power source. The on/off switch can be a pressure switch or a slide switch. The optional control circuit will control the duration of light emission by the plurality of light emitting diodes so the light display can provide a light pattern.

The forehead adhesive display can be a light display having a liquid crystal display.

The forehead adhesive display can have a sound display. A sound device is positioned between a first flexible display sheet and a second flexible display sheet underneath the display. The sound device will emit a suitable sound, such as a voice, a song, or a noise through the forehead adhesive display. The sound device will be electrically connected to a power source, and an on/off switch, all positioned between the first flexible display sheet and the second flexible display sheet. The power source can be a watch battery or any other thin flat power source. The on/off switch can be a pressure switch or a slide switch.

The foregoing and additional features and advantages of this invention will become apparent from the following more detailed description and accompanying drawings and figures.

### BRIEF DESCRIPTION OF THE DRAWINGS

The preferred embodiments of this invention will be described in detail, with reference to the following figures wherein:

FIG. 1 is a side view of the forehead adhesive display of the present invention with its flexible display sheet attached to a backing sheet.

FIG. 2 is a side view of the forehead adhesive display of the present invention with its flexible display sheet attached to the forehead of a wearer.

FIG. 3 is a front view of the forehead adhesive display of FIG. 2 of the present invention.

FIG. 4 is a side view of the curved forehead adhesive display of the present invention adjacent to the forehead of a wearer.

FIG. 5 is a front view of the forehead adhesive display of the present invention with a light emitting diode (LED) light display.

FIG. 6 is a side view of the forehead adhesive display of FIG. 5 of the present invention.

FIG. 7 is a front view of the forehead adhesive display of the present invention with a liquid crystal display (LCD) light display.

FIG. 8 is a side view of the forehead adhesive display of FIG. 7 of the present invention.

FIG. 9 is a side view of the forehead adhesive display of the present invention with a sound display.

### DETAILED DESCRIPTION OF THE INVENTION

Reference is now made to FIG. 1 illustrating the forehead adhesive display 10 of the present invention. The forehead adhesive display 10 has a flexible display sheet 12 with a top surface 14 and a bottom surface 16. A display 18 is printed on the top surface 14 of the flexible display sheet 12. A reusable adhesive 20 coats the bottom surface 16 of the flexible display sheet 12.

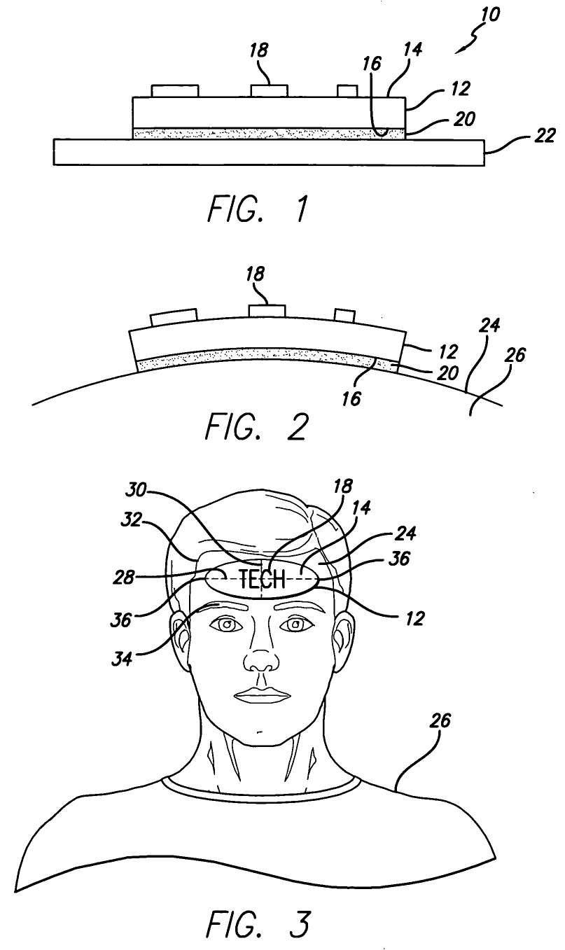

The adhesive 20 initially attaches the flexible display sheet 12 of the forehead adhesive display 10 to a backing sheet 22, as shown in FIG. 1. The flexible display sheet 12 can be peeled from the backing sheet 22 with the reusable adhesive still coating the bottom surface 16 of the flexible display sheet 12. The reusable adhesive 20 can then attach the flexible display sheet 12 of the forehead adhesive display 10 to the forehead 24 of the wearer 26, as shown in FIG. 2. The flexible display sheet 12 can be peeled from the forehead 24 of the wearer 26 with the reusable adhesive still coating the bottom surface 16 of the flexible display sheet 12. The reusable adhesive 20 can then attach the flexible display sheet 12 back onto the backing sheet 22 or some other surface, until the forehead adhesive display 10 is used again on the forehead of a wearer.

The flexible display sheet 12 should be thin, relatively soft and flexible. Possible display sheet materials would include, but are not limited to, be plastic, paper, polymer, cotton, metal foil or linen. The material should withstand exposure to the outdoor and indoor elements, and withstand perspiration of the wearer and wrinkling of the forehead. The material should also support the printing of the display on the top surface without bleed through or running over time. The material should also support the coating of the adhesive on the bottom surface without running of the adhesive over time. The poster should be non-allergenic and not cause a rash or markings on the skin.

The display 18 is printed on the top surface 14 of the flexible display sheet 12, as shown in FIG. 1, FIG. 2 and FIG. 3. The display 18 can be printed in ink or paint or some other substitute. The ink can be any color and the display can be any color or combination of colors.

The ink should withstand exposure to the outdoor and indoor elements, and withstand perspiration of the wearer 26 and wrinkling of the forehead 24. The ink should also remain on the display sheet without bleed through or running over time.

The ink for printing on the display sheet 12 should be temperature and moisture stable so it does not run in hot or cold temperatures, in dry or moist air. The ink should be non-allergenic and not cause a rash or markings on the skin.

The ink is printed on the front surface 14 of the display sheet 12 by printing means, including but not limited to, printing, embossing, stamping, thermal transfer, engraving, thermography, silk screening and painting.

As shown in FIG. 3, the display 18 can be, but is not limited to, a sports team nickname, a sports team name, a sports team logo, a sports team mascot, a sports slogan, a corporate nickname, a corporate name, a corporate logo, a corporate mascot, corporate advertising, a corporate slogan, a product or service name, a product or service logo, an advertising slogan, catchphrase or other slogan, a decorative pattern, a seasonal pattern or an ornamental pattern, a holiday theme pattern, a political message, a social message, a corporate message, a religious message, a personal message or blank. The display can be letters, numbers, symbols, graphics, geometric designs, non-geometric designs or some combination thereof.

Returning to FIG. 1 and FIG. 2, the reusable adhesive 20 coats the bottom surface 16 of the flexible display sheet 12. The reusable adhesive 20 is a low-tack, reusable, pressure sensitive, adhesive available from 3M Corporation and other commercial manufacturers.

A low-tack adhesive will adhere to the backing sheet and the forehead. A low-tack adhesive can be easily peeled away or easily removed from the backing sheet or forehead without leaving an adhesive residue on the backing sheet or forehead.

A reusable adhesive will adhere the display sheet to the backing sheet, can allow the display sheet to be easily peeled or removed from the backing sheet, will adhere the display sheet to the forehead of the wearer, can allow the display sheet to be easily peeled or removed from the forehead of the wearer, will adhere the display sheet to the backing sheet, a plurality of times.

A pressure sensitive adhesive will attach to the forehead or on the backing sheet just with the application of pressure on the display sheet. Solvents including water, radiation, heat, chemical reaction, cooling, and special equipment are not needed to attach and detach the adhesive coated display sheet.

The adhesive should stick to skin but also be easily removable and reattachable to the skin again. The adhesive should not run or slip in hot or cold temperatures, in dry or moist air, against dry or moist skin. The adhesive should not damage the backing sheet. The adhesive should be non-allergenic, non-toxic, and not cause a rash or markings on the skin.

Returning to FIG. 3, the flexible display sheet 12 of the forehead adhesive display 10 is generally oval or generally elliptical in shape on the forehead 24 of the wearer 26. The oval or elliptical flexible display sheet 12 can be different sizes for different size foreheads.

The forehead 24 is generally the largest area of exposed skin on the front of a wearer and the largest area of exposed hairless skin. A removable display attached to skin with hair will be painful to remove since it will pull and/or tear the attached hairs out of the skin.

The object of the display is to be viewed by a second party. The eyes of the second party are normally level with the eyes of the wearer. The most convenient location to be viewed by the second party is the forehead, just above the eyes. A display on the back of a wearer requires the wearer to be facing away from the viewer. The forehead adhesive display can also be worn with any clothing, without the clothing obscuring the display.

The oval or elliptical flexible display sheet 12 has a long axis 28 and a short axis 30. The long axis 28 of the oval display sheet 12 will run from the right side of the forehead 24 to the left side of the forehead 24 of the wearer 26. The short axis 30 of the oval display sheet will run from the top of the forehead 24 of the wearer, below where the hairline 32 is or should be, to the bottom of the forehead of the wearer, above where the eyebrow line 34 is or should be. The display sheet 12 can be smaller than the dimensions of the forehead.

The generally oval or generally elliptical shape of the flexible display sheet 12 of the forehead adhesive display 10 allows the flexible display sheet to fit the curving surface of the forehead 24.

A standard decal is generally rectangular in shape and meant to be attached to a flat surface. A typical flat, rectangular decal will wrinkle at the ends when applied to the forehead of a wearer. The curved ends 36 of the oval flexible display sheet of the forehead adhesive display in both the long axis 28 and the short axis 30 will diminish or eliminate wrinkles of the display sheet 14. The curved ends also make the forehead adhesive display easier for the wearer to grasp to peel off and remove the forehead adhesive display.

The forehead of the wearer can move or crinkle. An oval flexible display sheet of the forehead adhesive display will move with the forehead and reduce the possibility of accidental partial or full removal of the display sheet.

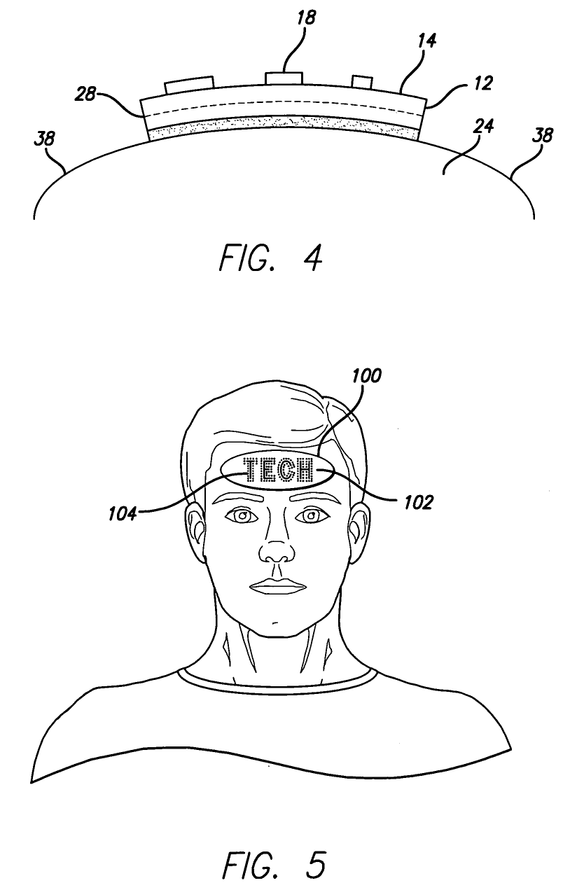

The oval or elliptical flexible display sheet 12 of FIG. 4 can be curved along the long axis 28 to better fit the slightly curved forehead 24 and the sharp curve 38 from the forehead to the side of the head on both sides. This curve to the flexible display sheet provides a more secure attachment of the display sheet to the forehead.

The display 18 is printed in ink on the top surface 14 of the flexible display sheet 12. The ink for printing the display can be a fluorescent ink or a luminescent ink. A fluorescent ink or a luminescent ink will illuminate the display, without the need for an electrical power source. Alternately, the background of the flexible display sheet, surrounding the display, can be in a fluorescent ink or a luminescent ink to highlight the display.

The forehead adhesive display 100 of FIG. 5 has a light emitting display (LED) light display 102. A plurality of light emitting diodes 104 illuminates the display 100. The display can still incorporate an ink display, in addition to the lighted aspect of the display. Alternately, the display can just be a light display.

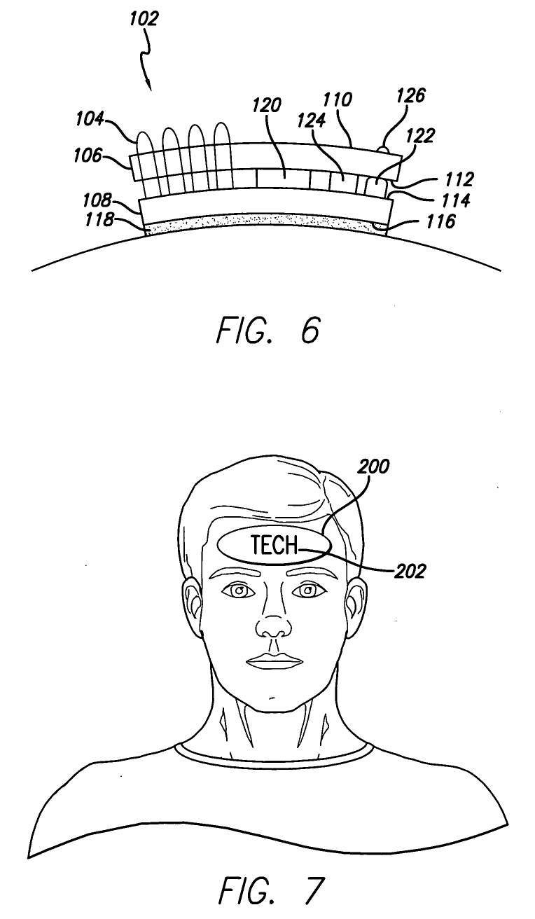

As seen in FIG. 6, the plurality of light emitting diodes 104 are positioned between a first flexible display sheet 106 and a second flexible display sheet 108. The plurality of light emitting diodes 104 extend through the first flexible display sheet 106 to form a display 102 on the top surface 110 of the first flexible display sheet 106. The bottom surface 112 of the first flexible display sheet 106 will be attached by a secure adhesive or other bonding means to the top surface 114 of the second flexible display sheet 108. The bottom surface 116 of the second flexible display sheet 108 will be coated with the reusable adhesive 118 for removable attachment to the forehead.

The plurality of light emitting diodes 104 will be electrically connected to a power source 120, an on/off switch 122 and, optionally, a control circuit 124. The power source 120 can be a watch battery or any other thin flat power source. The power source 120 will also be positioned between the first flexible display sheet 106 and the second flexible display sheet 108. The on/off switch 122 can be a pressure switch also positioned between the first flexible display sheet 106 and the second flexible display sheet 108. The wearer will push a specific location 126 on the top surface 110 of first flexible display sheet 106, above the pressure switch 122, to turn the light display 104 on and off. Alternately, the pressure switch 122 can be positioned on the top surface of the first flexible display sheet. The wearer will push the pressure switch on the first flexible display sheet on the forehead adhesive display, to turn the light display on and off. Again alternately, the on/off switch 122 can be a slide switch positioned on the top surface of the first flexible display sheet. The wearer will slide the switch in one direction to turn the light display on and slide the switch in the opposite direction to turn the light display off.

The optional control circuit 124 will also be positioned between the first flexible display sheet 106 and the second flexible display sheet 108. The control circuit 124 would be in the electrical circuit between the on/off switch 122, the power source 120 and plurality of light emitting diodes 104. The control circuit would control the duration of light emission by the plurality of light emitting diodes or would control the duration of light emission by each individual light emitting diode in the plurality of light emitting diodes 104. The control circuit would allow the light display 102 to provide a light pattern.

Alternately, the plurality of light emitting diodes, the power source, the on/off switch and the optional control circuit can be positioned on the top surface of a single flexible display sheet 106. Again alternately, the plurality of light emitting diodes, the power source, the on/off switch and the optional control circuit can be positioned on the bottom surface of a single flexible display sheet. The reusable adhesive either can coat all of the bottom surface including any exposed diodes, exposed power source, exposed switch, and exposed optional control circuit or can coat the bottom surface excluding any exposed diodes, exposed power source, exposed switch, and exposed optional control circuit. In the latter case, the adhesive can still attach the flexible display sheet to a forehead or back onto the backing sheet.

The plurality of light emitting diodes, the power source, the on/off switch and the optional control circuit will generate low or no heat against the forehead of the wearer.

The forehead adhesive display 200 of FIG. 7 has a liquid crystal display (LCD) light display 202. The flexible LCD display 202 should be thin, relatively lightweight, and flexible. The LCD display can be made from plastic, polymer or other flexible material. The LCD should withstand exposure to the outdoor and indoor elements, and withstand perspiration of the wearer and wrinkling of the forehead. The LCD should also support the coating of the adhesive on the bottom surface without running of the adhesive over time. The LCD should be non-allergenic and not cause a rash or markings on the skin. The LCD can still incorporate an ink display, in addition to the lighted aspect of the display. Alternately, the display can just be a light display. The light display can be static or animated (moving).

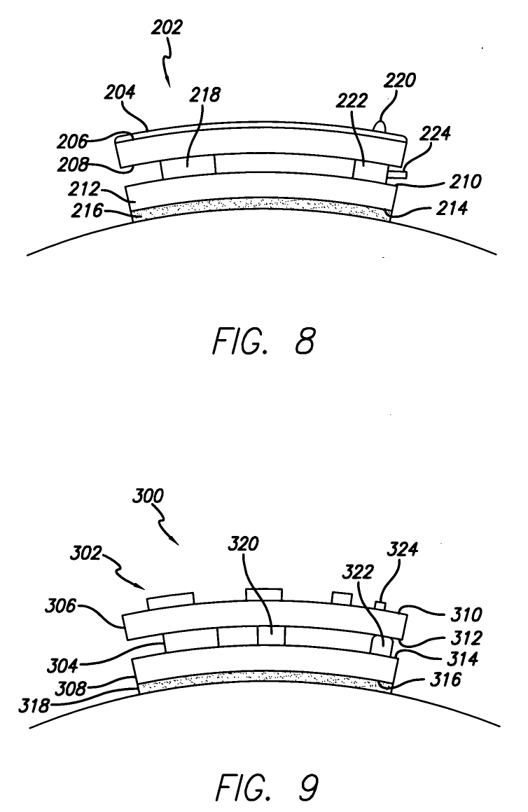

As seen in FIG. 8, the liquid crystal display (LCD) 202 has a screen 204 on the front surface 206 of the LCD. The bottom surface 208 of the LCD will be attached by a secure adhesive or other bonding means to the top surface 210 of a flexible display sheet 212. The bottom surface 214 of the flexible display sheet 212 will be coated with the reusable adhesive 216 for removable attachment to the forehead.

The liquid crystal display 202 will be electrically connected to a power source 218, an on/off switch 220 and, optionally, a control circuit 222. The power source 218 can be a watch battery or any other thin flat power source. The power source 218 will also be positioned between the liquid crystal display 202 and the flexible display sheet 212.

The on/off switch 220 can be a pressure switch positioned on the top surface 206 of the liquid crystal display 208. The wearer will push the pressure switch to turn the LCD light display 202 on and off. Alternately, the pressure switch can be on the top surface of the flexible display sheet in an area not covered by the liquid crystal display. The wearer will push the pressure switch on the flexible display sheet on the forehead adhesive display, to turn the light display on and off. Again alternately, the on/off switch 220 can be a slide switch positioned on the liquid crystal display or on the top surface of the flexible display sheet in an area not covered by the liquid crystal display. The wearer will slide the switch in one direction to turn the light display on and slide the switch in the opposite direction to turn the light display off.

The optional control circuit 222 will also be positioned between the liquid crystal display 202 and the flexible display sheet 212. The control circuit 222 would be in the electrical circuit between the on/off switch 220, the power source 218 and the liquid crystal display 202. The control circuit would control the light display by the liquid crystal display.

A wireless connection or a plug-in socket connection 224 to the control circuit 222 will allow the light display to be changed for the liquid crystal display 202. The light display can be stork or custom programmed by the wearer or a third party. The connection also allows the light display on the LCD to be constantly changed by the wearer or a third party. The light display can be used to communicate with a third party who views or reads the light display.

Alternately, the LCD will be attached by a secure adhesive or other bonding means to a first flexible display sheet. The first flexible display sheet is attached by a secure adhesive or other bonding means to a second flexible display sheet. The second flexible display sheet is coated with the reusable adhesive for removable attachment to the forehead. The power source and optional control circuit will be positioned between the first flexible display sheet and the second flexible display sheet. The on/off switch can be a pressure switch also positioned on the LCD, on the top surface of the first flexible display sheet in an area not covered by the liquid crystal display, or between the first flexible display sheet and the second flexible display sheet. The on/off switch can be a slide switch positioned on the LCD or on the top surface of the first flexible display sheet.

The LCD, the power source, the on/off switch and the optional control circuit will generate low or no heat against the forehead of the wearer.

The forehead adhesive display 300 of FIG. 9 has a sound display 302. A sound device 304 is positioned between a first flexible display sheet 306 and a second flexible display sheet 308 underneath the display 302. The sound device 304 will emit a suitable sound, such as a voice, a song, or a noise through the first flexible display sheet 306 of the forehead adhesive display 300 towards a second party, although the wearer can also hear the sound. The display can still incorporate an ink display, in addition to the sound aspect of the display. Alternately, the display can just be a sound display.

The display 302 is on the top surface 310 of the first flexible display sheet 306. The bottom surface 312 of the first flexible display sheet 306 will be attached by a secure adhesive or other bonding means to the top surface 314 of the second flexible display sheet 308. The bottom surface 316 of the second flexible display sheet 308 will be coated with the reusable adhesive 318.

The sound device 304 will be electrically connected to a power source 320, and an on/off switch 322. The sound device 304 will control the duration and volume of the sound from the sound device. The power source 320 can be a watch battery or any other thin flat power source. The power source 320 will also be positioned between the first flexible display sheet 306 and the second flexible display sheet 308. The on/off switch 322 can be a pressure switch also positioned between the first flexible display sheet 306 and the second flexible display sheet 308. The wearer will push a specific location 324 on the first flexible display sheet 306, above the pressure switch 322, to turn the sound device on and off. Alternately, the pressure switch can be positioned on the top surface of the first flexible display sheet. The wearer will push the pressure switch on the first flexible display sheet on the forehead adhesive display, to turn the sound device on and off. Again alternately, the on/off switch can be a slide switch positioned on the top surface of the first flexible display sheet. The wearer will slide the switch in one direction to turn the sound device on and slide the switch in the opposite direction to turn the sound device off. The on/off switch can also control the volume of the sound device.

Alternately, the sound device, the power source, and the on/off switch can be positioned on the top surface of a single flexible display sheet. Again alternately, the sound device, the power source, and the on/off switch can be positioned on the bottom surface of a single flexible display sheet. The reusable adhesive either can coat all of the bottom surface including any exposed sound device, exposed power source, and exposed switch or can coat the bottom surface excluding any exposed sound device, exposed power source, and exposed switch. In the latter case, the adhesive can still attach the flexible display sheet to a forehead or back onto the backing sheet.

The sound device, the power source, and the on/off switch will generate low or no heat against the forehead of the wearer.

A forehead adhesive display can have a light display and a sound display. The LED or LCD light display and the sound display can have separate power sources or share the same power source. The light display and sound display can have separate on/off switches or share the same on/off switch. The light display and sound display can have separate control circuits or share the same control circuit.

The invention is a display to be applied to the forehead of the wearer. The display is easy to apply, easy to remove, and reusable.

The forehead adhesive display has ink printing forming a display on a flexible display sheet with an adhesive backing. The flexible display sheet can be removably attached to a backing sheet or the forehead of a wearer.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A forehead adhesive display comprising
a generally oval flexible display sheet having a top surface and a bottom surface;
a display on said top surface of said generally oval flexible display sheet; and
a reusable adhesive on said bottom surface of said generally oval flexible display sheet, said reusable adhesive for attaching said generally oval flexible display sheet to the forehead of a wearer such that said display is viewable by a second party, wherein said generally oval flexible display sheet can be removed from said forehead of said wearer and re-attached to said forehead of said wearer.

2. The forehead adhesive display of claim 1 wherein said generally oval flexible display sheet is plastic, paper, polymer, cotton, metal foil or linen.

3. The forehead adhesive display of claim 1 wherein said reusable adhesive is a low-tack, reusable, pressure sensitive, adhesive.

4. The forehead adhesive display of claim 1 wherein said display is ink printed on the surface of said generally oval flexible display sheet.

5. The forehead adhesive display of claim 1 wherein said ink is a fluorescent or luminescent ink.

6. The forehead adhesive display of claim 1 wherein said display is a light display having a plurality of light emitting diodes.

7. The forehead adhesive display of claim 1 wherein said display is a light display having a liquid crystal display.

8. The forehead adhesive display of claim 1 wherein said display further comprises a sound device for emitting sound from said forehead adhesive display.

9. A forehead adhesive display comprising
a generally oval flexible display sheet having a top surface and a bottom surface, said generally oval flexible display sheet having a long axis and a short axis, said generally oval flexible display sheet being curved along said long axis;
a display on said top surface of said generally oval flexible display sheet; and
a reusable adhesive on said bottom surface of said generally oval flexible display sheet, said reusable adhesive for attaching said generally oval flexible display sheet to the slightly curved forehead of a wearer such that said display is viewable by a second party, said generally oval flexible display sheet being curved along said long axis providing a better attachment to said slightly curved forehead of a wearer, wherein said generally oval flexible display sheet can be removed from said forehead of said wearer and re-attached to said forehead of said wearer.

10. The forehead adhesive display of claim 9 wherein said generally oval flexible display sheet is plastic, paper, polymer, cotton, metal foil or linen.

11. The forehead adhesive display of claim 9 wherein said reusable adhesive is a low-tack, reusable, pressure sensitive, adhesive.

12. The forehead adhesive display of claim 9 wherein said display is ink printed on the surface of said generally oval flexible display sheet.

13. The forehead adhesive display of claim 9 wherein said ink is a fluorescent or luminescent ink.

14. The forehead adhesive display of claim 9 wherein said display is a light display having a plurality of light emitting diodes.

15. The forehead adhesive display of claim 9 wherein said display is a light display having a liquid crystal display.

16. The forehead adhesive display of claim 9 wherein said display further comprises a sound device for emitting sound from said forehead adhesive display.
